(19) United States
(12) Patent Application Publication
(10) Pub. No.: US 2019/0272475 A1
(43) Pub. Date: Sep. 5, 2019

(54) METHOD OF PERFORMING FAULT MANAGEMENT IN AN ELECTRONIC APPARATUS

(71) Applicant: Siemens Healthcare GmbH, Erlangen (DE)

(72) Inventors: Friedrich HEGENDOERFER, Weilersbach (DE); Marco MANCHINU, Spardorf (DE); Andre De OLIVEIRA, Uttenreuth (DE)

(73) Assignee: Siemens Healthcare GmbH, Erlangen (DE)

(21) Appl. No.: 16/281,478

(22) Filed: Feb. 21, 2019

(30) Foreign Application Priority Data
Mar. 1, 2018 (EP) 18159523.2

(51) Int. Cl. G06N 20/00; H04L 12/24

(52) U.S. Cl. CPC G06N 20/00; H04L 41/0654

(57) ABSTRACT

A method is for performing fault management in an electronic apparatus. In an embodiment, the method includes transferring machine data of the electronic apparatus to a remote support center; analyzing machine data of the electronic apparatus in the remote support center; providing at least one of a diagnostic workflow and a corrective workflow in response to an anomaly detected in the machine data; and operating the electronic apparatus from the remote support center to execute the at least one of a diagnostic workflow and the corrective workflow.

### PRIORITY STATEMENT

The present application hereby claims priority under 35 U.S.C. § 119 to European patent application number EP18159523.2 filed Mar. 1, 2018, the entire contents of which are hereby incorporated herein by reference.

### FIELD

At least one embodiment of the invention generally relates to a method of performing fault management in an electronic apparatus and a fault management system for electronic apparatus.

### BACKGROUND

An electronic apparatus can be any device that comprises components for performing one or more specific functions (e.g. imaging) as well as processors and controllers to control the components. An example of electronic apparatus may be a medical device, in particular a medical imaging apparatus such as an MRI (magnetic resonance imaging) scanner, a CT (computed tomograph) scanner, a PET (positron emission tomography) scanner, an X-Ray apparatus, etc. These types of electronic apparatus are generally very expensive machines and must be available essentially continuously in order to be cost-effective. The reliable performance of such electronic apparatus can be helped to some extent by regular maintenance and by ensuring that the customer or user of the machine has received appropriate training. However, faults or defects will eventually occur even when such measures are adhered to. To minimize downtime of such electronic apparatus, any fault or defect should be identified and remedied as quickly as possible.

Generally, the first indication of a fault or problem is an error code or warning message shown in a display of the electronic apparatus, for example in the display of an MRI scanner. The usual way of dealing with such a reported fault is for the user—medical personnel and/or a service technician—to first gather information about the fault, for example to note the warning or error code shown in the display. A next step can be to consult a manual to determine the cause of the defect, and to carry out any remedial steps associated with that warning or error code. However, a warning or an error code may be associated with various possible causes, so that the user may need to rely on experience in an attempt to identify the precise cause of the defect.

A service technician may connect a portable computer such as a tablet to the electronic apparatus in order to run a diagnostic program that may be able to identify the problem. However, it is often not possible to clearly identify the cause of the problem, and various possible solutions must be tried in an effort to localize a fault. For example, in an attempt to solve a problem in an MRI scanner, the user may replace one of the coils and then run a test sequence to see whether or not the problem has been fixed. Clearly, such an approach involves guesswork and may be quite effective, resulting in significant and unnecessary costs by replacing parts that were not even defective. Furthermore, the time spent looking for the fault can involve machine downtime and/or service technician effort, both of which can result in significant costs.

### SUMMARY

An embodiment of the invention provides a more efficient and cost-effective way of dealing with defects in such electronic apparatus.

Embodiments are directed to a method of performing fault management in electronic apparatus; a fault management system; and a computer program product.

According to an embodiment of the invention, a method of performing fault management in electronic apparatus comprises transferring machine data of the electronic apparatus to a remote support center (referred to in the following as the “backend”); analyzing the machine data of the electronic apparatus in the backend; providing a diagnostic/corrective workflow in response to an anomaly detected in machine data; and operating the electronic apparatus from the backend to execute the diagnostic or corrective workflow.

According to an embodiment of the invention, a method of performing fault management in at least one electronic apparatus, the method comprising:
transferring machine data of at least one of the at least one electronic apparatus to a remote support center;
analyzing machine data of the at least one electronic apparatus in the remote support center;
providing at least one of a diagnostic workflow and a corrective workflow in response to an anomaly detected in the machine data; and
operating the at least one electronic apparatus from the remote support center to execute the at least one of a diagnostic workflow and the corrective workflow.

According to an embodiment of the invention, the fault management system comprises device(s) for transferring machine data of electronic apparatus to a backend; and an analysis arrangement realized to analyze the machine data of the electronic apparatus in the backend and to identify a diagnostic workflow in response to an anomaly detected in a machine data.

A fault management system for at least one electronic apparatus, comprising:
at least one device to transfer machine data of at least one of the at least one electronic apparatus to a remote support center; and
an analysis arrangement to analyze machine data of the at least one electronic apparatus in the remote support center and to provide at least one of a diagnostic workflow and a corrective workflow in response to an anomaly detected in machine data.

An embodiment of the invention is also achieved by a computer program product that is capable of carrying out an embodiment of the inventive method when loaded into a programmable device of the electronic apparatus fault management system. The computer program product can comprise a computer program that is directly loadable into the memory of a control unit of the electronic apparatus fault management system, and which comprises program units to perform the steps of an embodiment of the inventive method when the program is executed by the control unit.

A computer readable medium such as a memory stick, a hard-disk or other transportable or permanently-installed carrier can serve to transport and/or to store the executable parts of the computer program product so that these can be read by a processor unit of the fault management system. A processor unit can comprise one or more microprocessors or their equivalents.

In a particularly preferred embodiment of the invention, the electronic apparatus comprises one or more medical imaging devices such as an MRI scanner, a CT scanner, a PET scanner, an X-Ray apparatus, etc.

Particularly advantageous embodiments and features of the invention are given by the claims, as revealed in the following description. Features of different claim categories may be combined as appropriate to give further embodiments not described herein.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows an embodiment of the inventive fault management system;

FIG. 2 shows a block diagram of an analysis arrangement in an embodiment of the inventive fault management system;

FIG. 3 shows a prior art environment including medical devices and a remote service center.

In the diagrams, like numbers refer to like objects throughout. Objects in the diagrams are not necessarily drawn to scale.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Most of the aforementioned components, in particular the identification unit, can be implemented in full or in part in the form of software modules in a processor of a suitable control device or of a processing system. An implementation largely in software has the advantage that even control devices and/or processing systems already in use can be easily upgraded by a software update in order to work in the manner according to at least one embodiment of the invention.

According to an embodiment of the invention, a method of performing fault management in electronic apparatus comprises transferring machine data of the electronic apparatus to a remote support center (referred to in the following as the “backend”); analyzing the machine data of the electronic apparatus in the backend; providing a diagnostic/corrective workflow in response to an anomaly detected in machine data; and operating the electronic apparatus from the backend to execute the diagnostic or corrective workflow.

The term “backend” has its origin in information systems, and generally refers to a database management system (DBMS) which can store and analyze large quantities of data. A database management system may also be assumed to include software such as a web server or application server to perform data processing.

An embodiment of the inventive fault management method is to be understood as being autonomous in the sense that the steps of analyzing the machine data, providing a diagnostic/corrective workflow and remotely operating the electronic apparatus do not require any user participation or intervention. In the context of an embodiment of the invention, a “workflow” is to be understood as a set of instructions for an electronic apparatus. This instruction set can cause the apparatus to perform a defined sequence of tasks, for example a workflow can make an apparatus start up, actuate one or more components to perform one or more tasks, record information resulting from the task, etc. In the case of a medical device such as an MRI scanner, a workflow can cause the scanner to start up and then to deploy various components such as the coils to perform test sequences, to record sensor readings during these test sequences, and subsequently to shut the scanner down again.

In an embodiment of the inventive method, machine data from an electronic apparatus are transferred to the backend during normal operation of the electronic apparatus, i.e. in real-time. As a result, the inventive method can continually collect normal operating information from any electronic apparatus being supported by that backend. Analysis of the machine data can therefore continually run in the background without any need for a user of the electronic apparatus to initiate a diagnostic session.

An advantage of an embodiment of the inventive method is that it overcomes the limitations of the prior art approach of running test routines which are generally only run after a problem has been reported by an error code or warning message. As explained above, the prior art usually involves some guesswork, for example running test routines in an attempt to identify the source of a problem and/or replacing parts in the attempt to localise a problem even if there is no clear indication that the exchanged part is faulty.

In contrast, the approach taken by an embodiment of the inventive method is to apply artificial intelligence at an interface between the electronic apparatus and the backend, and to analyze the machine data. The term “artificial intelligence” is to be understood in its established context, i.e. to include any suitable machine learning algorithm such as a neural network. Machine data of an electronic apparatus is to be understood as any information generated by the electronic apparatus in the course of normal operation, for example in the course of an imaging task.

For example, machine data of an MR device can comprise the machine parameters for that imaging task, a series of statements summarizing the steps of the imaging procedure, sensor output values, etc. The machine parameters can be parameters that were set by the user and/or parameters that are set by the device itself. Such machine data may also include one or more images generated during the imaging task.

In an embodiment of the inventive method, machine data are analyzed and compared to expected content so that any departure from the expected performance can be immediately identified and evaluated. If such a discrepancy is detected and considered significant, the backend identifies one or more diagnostic/corrective workflows (or “service software workflows”) that will likely locate the cause of the unexpected behavior. A workflow can serve to diagnose a problem (diagnostic workflow) and/or to correct or remedy the problem (corrective workflow). In the following, the term diagnostic workflow may be assumed to also comprise corrective workflow elements even if not explicitly stated.

The electronic apparatus is operated from the backend to execute the diagnostic workflow. In other words, the backend controls the electronic apparatus to carry out the diagnostic workflow. Any machine data generated during the diagnostic workflow is transferred to the backend so that the outcome of the diagnostic workflow can be immediately evaluated.

It may be that the problem can be dealt with remotely by altering a device parameter or device setting from the remote service center. Equally, if a fault can be identified and the problem can be dealt with by the medical personnel on site, the remote service center can provide a set of instructions (for example to exchange a defective part). If the problem can only be dealt with by a service technician, this can be scheduled. If the problem was not identified in the diagnostic workflow, an alternative workflow can be chosen and the process can be repeated. The inventive approach can therefore lead to significant savings by avoiding unnecessary replacement of non-defective parts. The number of service personnel site visits can also be reduced so that savings may be made here also.

An embodiment of the inventive method also makes it possible to identify system-specific corrective actions which can be performed even before a problem has actually become noticeable. An embodiment of the inventive method can therefore maximize system uptime and can avoid or reduce service contract uptime violations.

According to an embodiment of the invention, the fault management system comprises device(s) for transferring machine data of electronic apparatus to a backend; and an analysis arrangement realized to analyze the machine data of the electronic apparatus in the backend and to identify a diagnostic workflow in response to an anomaly detected in a machine data.

An embodiment of the invention is also achieved by a computer program product that is capable of carrying out an embodiment of the inventive method when loaded into a programmable device of the electronic apparatus fault management system. The computer program product can comprise a computer program that is directly loadable into the memory of a control unit of the electronic apparatus fault management system, and which comprises program units to perform the steps of an embodiment of the inventive method when the program is executed by the control unit.

Particularly advantageous embodiments and features of the invention are given by the claims, as revealed in the following description. Features of different claim categories may be combined as appropriate to give further embodiments not described herein.

In a particularly preferred embodiment of the invention, the electronic apparatus comprises one or more medical imaging devices such as an MRI scanner, a CT scanner, a PET scanner, an X-Ray apparatus, etc.

In the following, but without restricting the invention in any way, it may be assumed that an electronic apparatus comprises a medical device such as an MRI scanner or a CT scanner, so that the terms “electronic apparatus” and “medical device” may be used interchangeably. Such medical devices are usually designed to record every action or event, as well as any machine settings or parameters. Information entered by a user may also be recorded. Information generated by the machine during a task or workflow is generally also recorded. Collectively, this information is referred to as the “machine data” or “performance log”, and these terms may also be used interchangeably in the following.

In the following, it may be assumed that the remote support center or backend is capable of providing support for any number of medical devices that may be located at one or more customer sites such as hospitals, clinics, research facilities, etc.

When a medical device such as an MRI scanner or a CT scanner is set up to perform an imaging task for a patient, information pertaining to the patient is generally entered into the machine and stored with the image data that is generated during the imaging task. Since this information is then part of the performance log, steps are preferably taken to anonymise the patient data before transmitting the data to the remote service center.

Furthermore, this information comprises sensitive data that should be protected and prevented from access by third parties. Therefore, without restricting the invention in any way, it may be assumed in the following that communication between a medical device and the remove service center is carried out over a secure connection, for example using a VPN (virtual private network) to enable information to be exchanged between the customer site and the remote support center or backend using a public network such as the internet. Preferably, the medical device fault management system is realized to allow operation of the medical device from the backend, i.e. to execute a diagnostic workflow without any interaction from a user at the medical device location.

In an embodiment of the inventive method, analysis of real-time machine data can reliably identify an existing problem or even a potential problem, i.e. a problem that has not yet developed to the point where the medical device would issue a warning or error message. An embodiment of the inventive method applies artificial intelligence to identify a diagnostic workflow, i.e. a system-specific automated workflow. The diagnostic workflow is uploaded from the backend directly to the medical device and executed on the electronic apparatus.

The interface between the electronic apparatus and the remote service center carries out the machine data analysis and diagnostic workflow selection autonomously and without any user interaction. The “interface” between the medical device and the remote service center may therefore be understood as an “artificial intelligence interface” or “AI interface”, since it can learn from machine data to deduce diagnostic information and can autonomously apply this information by initiating remote execution of a suitable diagnostic workflow. For example, when a system-specific automated workflow is run on a medical device such as a Magnet Resonance Imaging System, the performance data collected during the workflow may indicate an unexpected result.

In an embodiment of the inventive method, a diagnostic workflow that will likely pinpoint this problem is created, or chosen from a set of already existing workflows, and executed remotely from the service center. The machine data of the diagnostic workflow is analyzed in real time to determine whether or not the problem was localized. The AI interface furthermore will try to home in on the root cause of the problem by identifying one or more specific part(s) that might possibly be defective and which might need to be replaced.

In the above example, a dedicated diagnostic workflow explicitly chosen or created by the AI interface is sent to the Magnet Resonance Imaging system. The diagnostic workflow runs on the MRI system to collect information about potentially defective parts. The machine data collected during the diagnostic workflow is evaluated. The outcome may be that some of the potentially defective parts turn out to be alright, and the problem can be pinpointed in a single part. A suggested remedy may be to replace that part if the AI evaluation indicates that the part is truly defective. Alternatively, the AI evaluation might indicate that an adjustment procedure (tuning) might solve the problem. In this way, failure of a part (e.g. a coil, a transmitter, a receiver, etc.) can be avoided by running an adjustment procedure in good time, thereby avoiding unnecessary part replacement. Either way, costly downtime is avoided.

The artificial intelligence arrangement can implement any suitable machine learning method, for example a random tree. Preferably, the artificial intelligence interface implements a method that comprises an artificial neural network. This can be realized in any suitable manner. For example, the artificial neural network can be realized as a deep neural network or a deep belief network.

The artificial neural network can simply be fed with machine data as they are generated by any medical device supported by the remote service center. As indicated above, machine data can comprise parameter values of the medical device, for example input settings, voltage and current curves, sensor output values, etc. A specific imaging task with a certain set of input parameters should result in a corresponding performance log. The step of analyzing machine data preferably comprises detecting any deviation from an expected pattern in the performance log.

The artificial neural network learns to identify expected content in machine data and to recognize any departure from such expected content. This learning can be done in a supervised manner initially if required; alternatively the artificial neural network may be allowed to learn in an entirely unsupervised manner. The artificial neural network can learn from a database of machine data collected in the past, for example. A favorably high accuracy of the artificial neural network at the outset can be achieved by providing a sufficiently large database from which the artificial neural network can learn.

By continually learning from collected machine data over weeks, months or even years of use under various conditions, the inventive method can continually refine, extend and improve a set of diagnostic workflows for medical devices such as MRI scanners, CT scanners, or any electronic apparatus that generates comprehensive machine data. An advantage of the inventive method is that optimization of diagnostic workflows is taken care of in the backend. Of course, improvements arising from analysis of the machine data can be used to benefit electronic apparatus by installing appropriate software updates at a convenient time, for example during a scheduled maintenance procedure. For example, the intelligent interface may have learned that development of a certain fault is associated with a specific pattern of reports from a particular sensor, and a software update can be prepared that generates a suitable warning message to alert the user of the electronic apparatus in good time.

Machine data from an imaging device such as an MRI scanner may also include the (anonymized) image data. Here, the step of analyzing the machine data preferably also comprises a step of assessing the quality of the image data. Image quality must be high in order for a correct diagnosis to be made for that patient. However, the quality of the images generated by such a medical device depends on many factors, for example signal-to-noise ratio, stability of the base field, gradient gain, etc. Even for trained medical personnel, it can be difficult and time-consuming to identify the reason for poor image quality. In the inventive method, it is relatively easy for the artificial intelligence interface to provide a diagnostic workflow that can find the cause of a decrease in image quality, and to suggest remedial action in order to improve image quality in subsequent imaging tasks. This can favorably reduce or eliminate the need to repeat expensive imaging procedures.

As indicated above, a diagnostic workflow for an electronic apparatus is preferably created and/or optimized on the basis of knowledge obtained from the analysis of multiple instances or sets of machine data. The knowledge obtained from the analysis of multiple instances or sets of machine data can comprise any of event history (service activity data) for that electronic apparatus type; a defect history (compendium of all defects including solution results as available from previous activities) for that electronic apparatus type; spare part consumption history (parts in/parts out) for that electronic apparatus type, etc. Such a collection of information may be regarded as “big data” from which suitable workflows may be created for the electronic apparatus.

Any diagnostic workflow is preferably uploaded from the backend to the electronic apparatus, and the electronic apparatus is operated remotely from the backend to execute the diagnostic workflow. Of course, if necessary or if preferred, the electronic apparatus can be operated locally by a service technician in order to execute an uploaded diagnostic workflow.

Various units or modules of the fault management system mentioned above can be completely or partially realized as software modules running for example on a processor of a suitable control unit of the fault management system, for example a control unit of the analysis arrangement. A realisation largely in the form of software modules can have the advantage that applications already operational in an existing remote service center system can be updated, with relatively little effort, to install and run the fault management method of the present application.

A computer readable medium such as a memory stick, a hard-disk or other transportable or permanently-installed carrier can serve to transport and/or to store the executable parts of the computer program product so that these can be read by a processor unit of the fault management system. A processor unit can comprise one or more microprocessors or their equivalents.

In the diagrams, like numbers refer to like objects throughout. Objects in the diagrams are not necessarily drawn to scale.

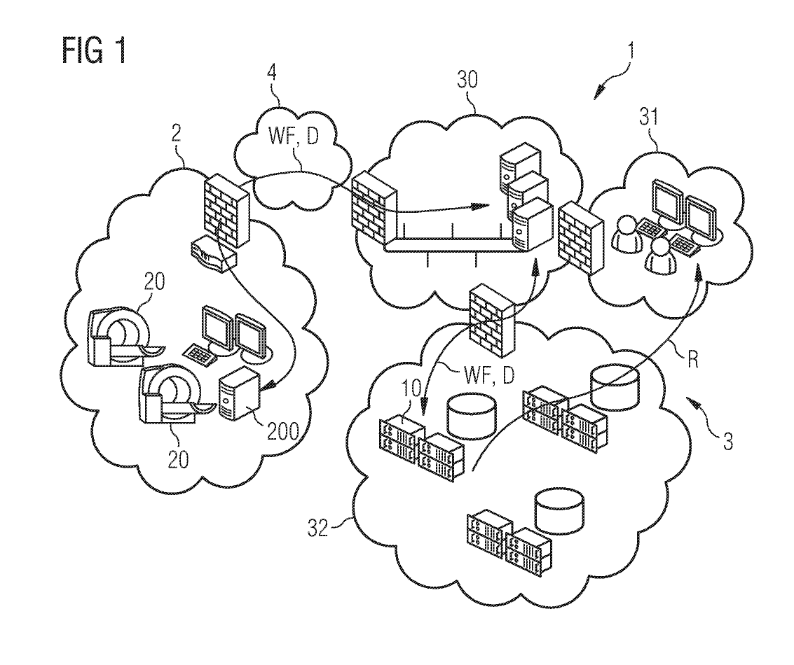

FIG. 1 shows an embodiment of the inventive fault management system 1, giving a simplified overview of the relationship between the various elements. Here, a customer local area network (LAN) 2 is shown to include electronic apparatus 20 in the form of two example medical devices 20, in this case imaging devices 20. Of course, the customer LAN—which may be a hospital LAN—may include any number of medical devices.

A medical device 20 is operated by way of a computer interface 200 indicated on the right. A user or device operator may set up the imaging device 20 for a specific task with the user interface (keyboard, monitor, etc.). The medical device 20 generates machine data D during operation, and this is sent (usually in encrypted form) over a wide-area network (WAN) internet to a perimeter network 30 or “demilitarized zone” 30 of a remote service center (RSC) 3. Protective firewall measures are indicated by the “wall” symbols. The RSC 3 can support any number of customers, but for the sake of clarity only one customer is indicated here by the customer LAN 2. The RSC 3 further comprises an intranet 31 that allows service center personnel to monitor any devices supported by that remote service center. Data storage and data analytics are outsourced to a data management zone 32 for managing storage of large volumes of data and for performing computationally intensive analytical tasks.

From the demilitarized zone 30, the machine data D are passed directly to an analysis arrangement 10 in the data management zone 32 or DBMS 32. The analysis arrangement 10 applies artificial intelligence in the form of a neural network such as a deep learning network to analyze machine data D and to learn from machine data D to detect any discrepancy from expected content. If machine data D is considered to be “normal” i.e. to have a “no fault detected” status, the artificial intelligence module 10 will conclude that no remedial action is necessary. However, if an anomaly is detected, the artificial intelligence module 10 will choose a diagnostic workflow WF from a collection of existing diagnostic workflows, or will create a suitable diagnostic workflow WF. The workflow will be uploaded to the customer LAN 2 over the same communications channel (e.g. a secure VPN tunnel) and executed on the relevant electronic apparatus 20. Depending on the outcome of the diagnostic workflow WF, personnel at the RSC 3 may be informed and/or the user at the customer LAN 2 may be instructed to carry out remedial actions.

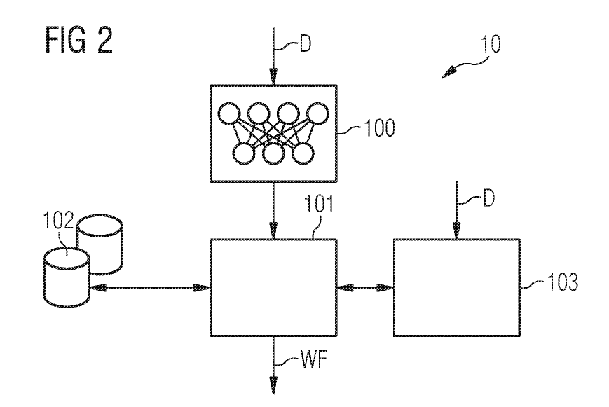

FIG. 2 shows a block diagram of an example analysis arrangement 10. One or more sets of machine data D are received by an artificial intelligence module 100 such as a deep neural network 100. While only a single set or instance of machine data D may be received at any one time from an electronic apparatus, multiple sets or instances of machine data D may be received over time, and these all contribute to the learning development of the deep neural network 100. This analyzes machine data D with the aim of detecting any anomaly or departure from an expected content. If the machine data D indicates that the medical device is not operating satisfactorily, the analysis arrangement 10 identifies a suitable diagnostic/corrective workflow WF, either by choosing it from an existing workflow collection 102 or by running a workflow generator 103 to create a new diagnostic/corrective workflow using device-relevant information from the machine data D. As indicated in FIG. 1, the workflow WF is uploaded to the medical device 20 and executed. This step is also performed remotely, i.e. from the RSC 3 and without any interaction required on the part of the customer (medically trained personal on site 2) or the service center personnel.

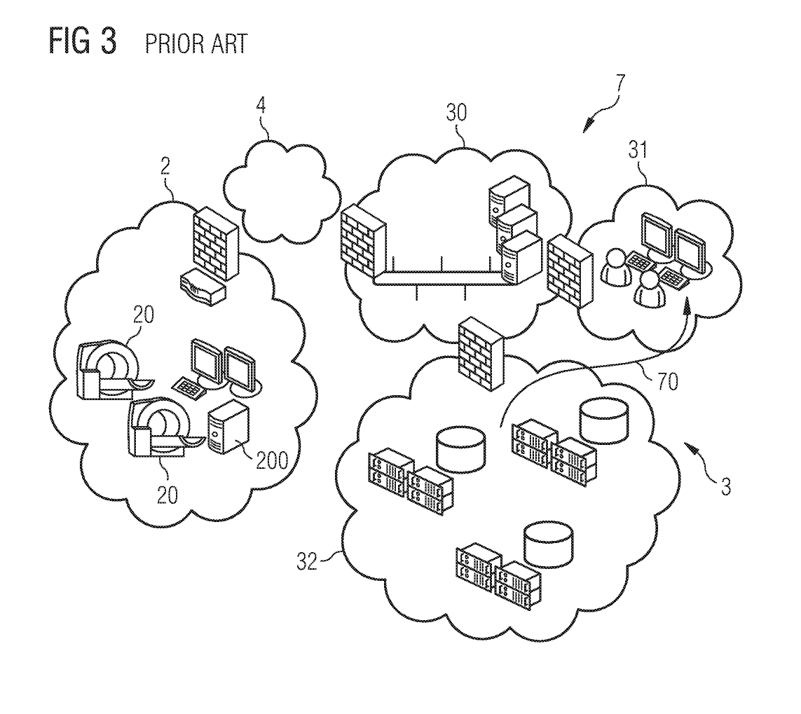

FIG. 3 shows a prior art environment 7 with a customer local area network (LAN) 2 and a remote service center 3. The configuration is similar to that of FIG. 1, with medical devices 20 of a customer LAN 2 connected via a WAN 4 to an RSC 3, and with data storage and data analytics outsourced to an external provider 32. However, in the prior art, a complex fault in an electronic apparatus may have multiple potential root causes so that it can only be identified by trial and error for example by replacing parts and then checking to see if the problem has been fixed. Alternatively, if a problem is identified by RSC personnel, these may notify the customer by updating relevant web application pages or by telephone/e-mail contact, for example.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### REFERENCE NUMERALS

fault management system 1
analysis arrangement 10
neural network 100
workflow selection module 101
workflow collection 102
workflow generator 103
electronic apparatus 2
controller 20
remote support center 3
DMZ 30
remote services intranet 31
data management provider 32
customer LAN 4
WAN 5
prior art system 7
error information 70
machine data D
diagnostic workflow WF
RSC report R

1. A method of performing fault management in at least one electronic apparatus, the method comprising:
transferring machine data of at least one of the at least one electronic apparatus to a remote support center;
analyzing the machine data of the at least one electronic apparatus in the remote support center;
providing at least one of a diagnostic workflow and a corrective workflow in response to an anomaly detected in the machine data; and
operating the at least one electronic apparatus from the remote support center to execute the at least one of the diagnostic workflow and the corrective workflow.

2. The method of claim 1, wherein the transferring of machine data from the at least one electronic apparatus includes transferring of machine data from at least one of an MRI scanner, a CT scanner, a PET scanner, and an X-Ray apparatus.

3. The method of claim 1, wherein the analyzing of machine data of the at least one electronic apparatus is performed by an artificial intelligence arrangement.

4. The method of claim 3, wherein the artificial intelligence arrangement implements a machine learning method.

5. The method of claim 1, wherein machine data includes parameter values of an electronic apparatus, and wherein the analyzing of the machine data includes at least one of detecting a deviation from an expected pattern and learning to recognize a new pattern.

6. The method of claim 1, wherein the machine data includes image data generated by the at least one electronic apparatus, and wherein the analyzing of the machine data includes assessing a quality of the image data.

7. The method of claim 1, further comprising creating at least one of the diagnostic workflow and the corrective workflow based upon knowledge obtained from analyzing of multiple machine data sets.

8. The method of claim 1, further comprising:
optimizing at least one of the diagnostic workflow and the corrective workflow for the at least one electronic apparatus based upon knowledge obtained from analyzing of multiple machine data sets.

9. The method of claim 1, wherein the at least one of the diagnostic workflow and the corrective workflow for the at least one electronic apparatus is optimized according to any of: an event history for a type of the at least one electronic apparatus; a defect history for a type of the at least one electronic apparatus; and spare part consumption history for a type of the at least one electronic apparatus.

10. The method of claim 1, wherein the at least one of the diagnostic workflow and the corrective workflow is uploaded from the remote support center to the at least one electronic apparatus.

11. The method of claim 1, wherein machine data is analyzed in the remote support center during execution of the at least one of the diagnostic workflow and the corrective workflow on the at least one electronic apparatus.

12. The method of claim 1, wherein the at least one electronic apparatus is operated remotely from the remote support center to execute the at least one of the diagnostic workflow and the corrective workflow.

13. A fault management system for at least one electronic apparatus, comprising:
at least one device to transfer machine data of at least one of the at least one electronic apparatus to a remote support center; and
an analysis arrangement to analyze machine data of the at least one electronic apparatus in the remote support center and to provide at least one of a diagnostic workflow and a corrective workflow in response to an anomaly detected in machine data.

14. The fault management system of claim 13, realized to allow operation of the at least one electronic apparatus from the remote support center to carry out at least one of the diagnostic workflow and the corrective workflow.

15. A non-transitory computer program product storing a computer program, directly loadable into a memory of a control unit of a fault management system, including program elements for performing the method of claim 1 when the computer program is executed by the control unit of the fault management system.

16. The method of claim 2, wherein the analyzing of machine data of the at least one electronic apparatus is performed by an artificial intelligence arrangement.

17. The method of claim 16, wherein the artificial intelligence arrangement implements a machine learning method.

18. The method of claim 4, wherein the machine learning method includes an artificial neural network.

19. The method of claim 2, wherein machine data includes parameter values of the at least one electronic apparatus, and wherein the analyzing of the machine data includes at least one of detecting a deviation from an expected pattern and learning to recognize a new pattern.

20. The method of claim 2, wherein the machine data includes image data generated by the at least one electronic apparatus, and wherein the analyzing of the machine data includes assessing a quality of the image data.

21. A non-transitory computer readable medium storing a computer program, directly loadable into a memory of a control unit of a fault management system, including program elements for performing the method of claim 1 when the computer program is executed by the control unit of the fault management system.
